(19) United States
(12) Patent Application Publication
(10) Pub. No.: US 2022/0194376 A1
(43) Pub. Date: Jun. 23, 2022

(54) VEHICLE CONTROL APPARATUS

(71) Applicant: Honda Motor Co., Ltd., Tokyo (JP)

(72) Inventors: Yohei Kitahara, Wako-shi (JP); Naoto Hiramatsu, Wako-shi (JP); Yoshimitsu Murahashi, Wako-shi (JP)

(21) Appl. No.: 17/551,575

(22) Filed: Dec. 15, 2021

(30) Foreign Application Priority Data
Dec. 23, 2020 (JP) 2020-213183

(51) Int. Cl. B60W 30/18; G08G 1/0967; B60W 10/04; B60W 10/18

(52) U.S. Cl. CPC B60W 30/181; G08G 1/096725; B60W 30/18154; B60W 10/04; B60W 10/18; B60W 2520/10; B60W 2552/05; B60W 2555/60; B60W 2720/10; B60W 2710/18; B60W 2552/53

(57) ABSTRACT

A vehicle control apparatus includes a detection unit detecting a traveling position and a traveling speed of a subject vehicle and a microprocessor and a memory. The microprocessor is configured to perform acquiring a scheduled switching information of a traffic light located in the traveling direction of the subject vehicle, determining whether to perform a stop operation of stopping the subject vehicle at the road stop line based on the scheduled switching information, the traveling position and the traveling speed, and when it is determined to perform the stop operation, decelerating the subject vehicle at a deceleration equal to or less than a predetermined deceleration until the display mode is switched from the green color mode to the red color and decelerates the subject vehicle so that the subject vehicle stops at the stop line after the display mode is switched to the red color.

### CROSS-REFERENCE TO RELATED APPLICATION

This application is based upon and claims the benefit of priority from Japanese Patent Application No. 2020-213183 filed on Dec. 23, 2020, the content of which is incorporated herein by reference.

### BACKGROUND OF THE INVENTION

### Field of the Invention

This invention relates to a vehicle control apparatus configured to control a stop operation of a vehicle.

### Description of the Related Art

Conventionally, there is a known apparatus of this type, configured to acquire a time until a light color of a traffic light is switched to a red color via road-to-vehicle communication or the like when a vehicle passes through an intersection where the traffic light is installed, and determines whether or not the vehicle can pass through the intersection without stopping based on the acquired time, a current position of the vehicle, and a traveling speed of the vehicle. Such a device is disclosed, for example, in JP 2017-91151 A. The device described in JP 2017-91151 A accelerates a vehicle so that the vehicle can pass through an intersection without stopping when determining that the vehicle cannot pass through the intersection without stopping.

When the time until the light color of the traffic light is switched to a red color is short, it is preferable to start deceleration before the light color is switched to the red color and satisfactorily stop at a road stop line at the time of switching to the red color. However, an occupant feels uncomfortable when deceleration is started before the light color is switched to the red color.

### SUMMARY OF THE INVENTION

An aspect of the present invention is a vehicle control apparatus including a detection unit configured to detect a traveling position and a traveling speed of a subject vehicle, and a microprocessor and a memory coupled to the microprocessor. The microprocessor is configured to perform acquiring a scheduled switching information of a traffic light located in the traveling direction of the subject vehicle and configured so that a display mode is switched among a first display mode indicating a travel permission, a third display mode indicating a stop instruction at a road stop line and a second display mode indicating a notice of switching from the first display mode to the third display mode, determining whether to perform a stop operation of stopping the subject vehicle at the road stop line based on the traveling position and the traveling speed detected by the detection unit and a margin time required until the display mode is switched from the first display mode to the third display mode included in the scheduled switching information acquired in the acquiring, and when it is determined to perform the stop operation, decelerating the subject vehicle at a deceleration equal to or less than a predetermined deceleration until the display mode is switched from the first display mode to the second display mode, and decelerates the subject vehicle so that the subject vehicle stops at the road stop line after the display mode is switched to the second display mode.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a vehicle control system according to an embodiment of the present invention;

FIG. 2 is a block diagram schematically illustrating an overall configuration of the vehicle control system according to an embodiment of the present invention;

FIG. 3 is a diagram illustrating an example of an intersection;

FIG. 4 is a block diagram illustrating a configuration of the controller in FIG. 2;

FIG. 5A is a diagram illustrating an example of a relationship between position and traveling speed of the vehicle during a stop operation;

FIG. 5B is a diagram illustrating another example of a relationship between position and traveling speed of the vehicle during a stop operation;

FIG. 5C is a diagram illustrating another example of a relationship between position and traveling speed of the vehicle during a stop operation; and

FIG. 6 is a flowchart showing an example of processing executed by a CPU of the controller in FIG. 4.

### DETAILED DESCRIPTION OF THE INVENTION

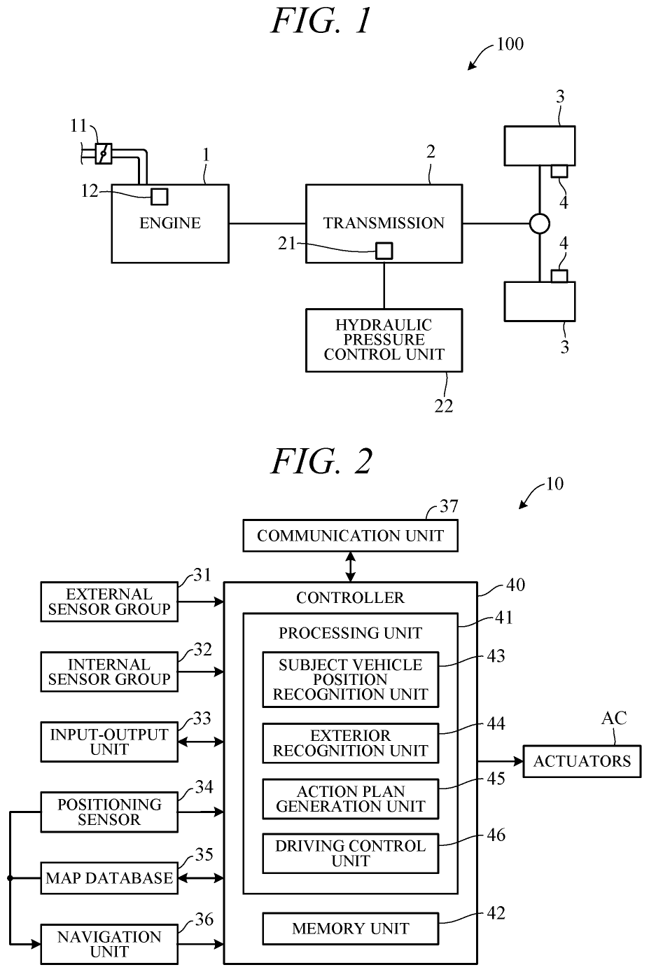

Hereinafter, an embodiment of the present invention is explained with reference to FIGS. 1 to 6. A vehicle control apparatus according to an embodiment of the present invention is applied to a vehicle (self-driving vehicle) having a self-driving capability. FIG. 1 is a diagram showing a configuration overview of a driving system of a self-driving vehicle 100 incorporating a vehicle control apparatus according to the present embodiment. Herein, the self-driving vehicle may be sometimes called “subject vehicle” to differentiate it from other vehicles. The vehicle 100 is not limited to driving in a self-drive mode requiring no driver driving operations but is also capable of driving in a manual drive mode by driver operations. In the present embodiment, a driving mode that does not require all operations including the accelerator pedal operation, brake operation, and steering operation is referred to as a self-driving mode.

As illustrated in FIG. 1, a vehicle 100 includes an engine 1 and a transmission 2. The engine 1 is an internal combustion engine (for example, a gasoline engine) that mixes intake air supplied via a throttle valve 11 and fuel injected from an injector 12 at an appropriate ratio, and ignites the mixture by an ignition plug or the like to burn the mixture, and thus to generate rotational power. Various engines such as a diesel engine can be used instead of the gasoline engine. An intake air amount is adjusted by the throttle valve 11, and an opening degree of the throttle valve 11 is changed by driving of a throttle actuator operated by an electric signal. The opening degree of the throttle valve 11 and an amount of fuel injected from the injector 12 (injection period, injection time) are controlled by a controller 40 (FIG. 2).

The transmission 2 is provided on a power transmission path between the engine 1 and a drive wheel 3, varies speed ratio of rotation of the engine 1, and converts and outputs a torque from the engine 1. The rotation varied by the transmission 2 is transmitted to the drive wheel 3, thereby propelling the vehicle 100. The vehicle 100 can be configured as an electric vehicle or a hybrid vehicle by providing a traveling motor as a drive power source instead of or in addition to the engine 1.

The transmission 2 is, for example, a stepped transmission enabling stepwise speed ratio according to a plurality of shift stages. A continuously variable transmission enabling stepless speed ratio shifting can also be used as the transmission 2. Although not illustrated, power from the engine 1 may be input to the transmission 2 via a torque converter. The transmission 2 includes, for example, an engagement element 21 such as a dog clutch or a friction clutch, and a hydraulic pressure control unit 22 controls a flow of oil from a hydraulic source to the engagement element 21, so that the shift stage of the transmission 2 can be changed. The hydraulic pressure control unit 22 includes a control valve driven by an electric signal, and can set an appropriate shift stage by changing a flow of pressure oil to the engagement element 21 according to the drive of the control valve.

FIG. 2 is a block diagram schematically illustrating an overall configuration of a vehicle control apparatus 10 according to the present embodiment. As illustrated in FIG. 2, the vehicle control apparatus 10 mainly includes a controller 40, an external sensor group 31, an internal sensor group 32, an input-output unit 33, a positioning sensor 34, a map database 35, a navigation unit 36, a communication unit 37, and traveling actuators (hereinafter, the traveling actuators are simply referred to as actuators) AC each electrically connected to the controller 40.

The external sensor group 31 is a generic term for a plurality of sensors that detect external circumstances which are peripheral information of the vehicle 100. For example, the external sensor group 31 includes a LIDAR (Light Detection and Ranging) that measures the scattered light to the irradiated light in all directions of the vehicle 100 to measure a distance from the vehicle 100 to surrounding obstacles, and a RADAR (Radio Detection and Ranging) that detects other vehicles, obstacles, and the like around the vehicle 100. Furthermore, for example, the external sensor group 31 includes a camera that is mounted on the vehicle 100, has an imaging element such as a CCD or a CMOS, and images a periphery (forward, reward and sideward) of the vehicle 100, a microphone that inputs a signal of sound from the periphery of the vehicle 100 (hereinafter, the microphone is simply referred to as a microphone), and the like. A signal detected by the external sensor group 31 and a signal input to the external sensor group 31 are transmitted to the controller 40.

The internal sensor group 32 is a collective designation encompassing a plurality of sensors that detect a traveling state of the vehicle 100 and a state inside the vehicle. For example, the internal sensor group 32 includes a vehicle speed sensor that detects a vehicle speed of the vehicle 100, an acceleration sensor that detects an acceleration in a front-rear direction of the vehicle 100 and an acceleration in a left-right direction (lateral acceleration) of the vehicle 100, an engine speed sensor that detects rotational speed of the engine 1, a yaw rate sensor that detects rotation angle speed around a vertical axis through the vehicle 100, a throttle position sensor that detects the opening degree (throttle opening) of the throttle valve 11, and the like. The internal sensor group 32 further includes a sensor that detects driver's driving operation in a manual drive mode, for example, operation of an accelerator pedal, operation of a brake pedal, operation of a steering wheel, and the like. A detection signal from the internal sensor group 32 is transmitted to the controller 40.

The input-output unit 33 is a generic term for devices in which a command is input from a driver or information is output to the driver. For example, the input-output unit 33 includes various switches to which the driver inputs various commands by operating an operation member, a microphone to which the driver inputs a command by voice, a display that provides information to the driver via a display image, a speaker that provides information to the driver by voice, and the like. The various switches include a mode select switch that instructs either a self-drive mode or a manual drive mode.

The mode select switch is configured as, for example, a switch manually operable by a driver, and outputs a mode select command to the self-drive mode in which a self-driving capability is enabled or the manual drive mode in which the self-driving capability is disabled according to a switch operation. Switching from the manual drive mode to the self-drive mode or switching from the self-drive mode to the manual drive mode can be instructed when a predetermined traveling condition is satisfied regardless of operation of the mode select switch. That is, by automatically switching the mode select switch, the mode can be automatically switched instead of manually switching.

The positioning sensor 34 is, for example, a GPS sensor, receives a positioning signal transmitted from a GPS satellite, and measures an absolute position (latitude, longitude, and the like) of the vehicle 100 based on the received signal. The positioning sensor 34 includes not only the GPS sensor but also a sensor that performs positioning using radio waves transmitted from a quasi-zenith orbit satellite. A signal (a signal indicating a measurement result) from the positioning sensor 34 is transmitted to the controller 40.

The map database 35 is a device that stores general map data used in the navigation unit 36, and is constituted of, for example, a hard disk. The map data includes road position data, road shape (curvature or the like) data, along with intersection and road branch position data. The map data stored in the map database 35 is different from high-accuracy map data stored in a memory unit 42 of the controller 40.

The navigation unit 36 is a device that searches for a target route on a road to a destination input by a driver and provides guidance along the target route. The input of the destination and the guidance along the target route are performed via the input-output unit 33. The target route is calculated based on a current position of the vehicle 100 measured by the positioning sensor 34 and the map data stored in the map database 35.

The communication unit 37 communicates with various servers not illustrated via a network including a wireless communication network such as an Internet, and acquires the map data, traffic data, and the like from the server periodically or at an arbitrary timing. The acquired map data is output to the map database 35 and the memory unit 42, and the map data is updated. The acquired traffic data includes traffic congestion data and traffic light data such as a remaining time until a traffic light changes from red light to green light.

The actuators AC are devices for operating various devices related to traveling operation of the vehicle 100. That is, the actuators AC are actuators for traveling. The actuators AC include a throttle actuator that adjusts the opening degree (throttle opening) of the throttle valve 11 of the engine 1 illustrated in FIG. 1, a shift actuator that changes the shift stage of the transmission 2 by controlling the flow of oil to the engagement element 21, a brake actuator that actuates a braking unit 4 which decelerate the vehicle 100, a steering actuator that drives a steering unit, and the like.

The controller 40 includes an electronic control unit (ECU). Although a plurality of ECUs having different functions such as an engine control ECU and a transmission control ECU can be separately provided, in FIG. 2, the controller 40 is illustrated as a set of these ECUs for convenience. The controller 40 includes a computer including a processing unit 41 such as a CPU, a memory unit 42 such as a ROM, a RAM, and a hard disk drive, and other peripheral circuits (not illustrated).

The memory unit 42 stores highly accurate detailed map data including data on a center position of a lane, data on a boundary of a lane position, and the like. More specifically, road data, traffic regulation data, address data, facility data, telephone number data, and other data are stored as the map data. The road data includes data indicating the type of road such as a highway, a toll road, and a national highway, and data such as the number of lanes of a road, the width of each lane, a road gradient, a three-dimensional coordinate position of the road, a curvature of a curve of the lane, positions of the merging point and branch point of the lane, a road sign, and the presence or absence of a median strip. The traffic regulation data includes data indicating that traveling on a lane is restricted or a road is closed due to construction or the like. The memory unit 42 also stores data such as a shift map (shift diagram) serving as a reference of shift operation, various control programs, and a threshold used in the programs.

The processing unit 41 includes a subject vehicle position recognition unit 43, an exterior recognition unit 44, an action plan generation unit 45, and a driving control unit 46 as functional configurations related to automatic travel.

The subject vehicle position recognition unit 43 recognizes the position (subject vehicle position) of the vehicle 100 on a map based on the position data of the vehicle 100 received by the positioning sensor 34 and the map data of the map database 35. The subject vehicle position may be recognized using the map data (building shape data and the like) stored in the memory unit 42 and the peripheral information of the vehicle 100 detected by the external sensor group 31, thereby the subject vehicle position can be recognized with high accuracy. When the subject vehicle position can be measured by a sensor installed on the road or outside a road side, the subject vehicle position can be recognized with high accuracy by communicating with the sensor via the communication unit 37.

The exterior recognition unit 44 recognizes external circumstances around the vehicle 100 based on the signal from the external sensor group 31 such as a LIDAR, a radar, and a camera. For example, the position, speed, and acceleration of a surrounding vehicle (a preceding vehicle or a rear vehicle) traveling around the vehicle 100, the position of a surrounding vehicle stopped or parked around the vehicle 100, and the positions and states of other objects are recognized. Other objects include signs, traffic lights, road boundaries, road stop lines, buildings, guardrails, power poles, signboards, pedestrians, bicycles, and the like. The states of other objects include a color of a traffic light (red, green, yellow), the moving speed and direction of a pedestrian or a bicycle, and the like.

The action plan generation unit 45 generates a driving path (target path) of the vehicle 100 from a present time point to a predetermined time ahead based on, for example, the target route calculated by the navigation unit 36, the subject vehicle position recognized by the subject vehicle position recognition unit 43, and the external circumstances recognized by the exterior recognition unit 44. When there are a plurality of trajectories that are candidates for the target path on the target route, the action plan generation unit 45 selects, from among the plurality of trajectories, an optimal path that satisfies criteria such as compliance with laws and regulations and efficient and safe traveling, and sets the selected path as the target path. Then, the action plan generation unit 45 generates an action plan corresponding to the generated target path.

The action plan includes travel plan data set for each unit time Δt (for example, 0.1 seconds) from a present time point to a predetermined time T (for example, 5 seconds) ahead, that is, travel plan data set in association with a time for each unit time Δt. The travel plan data includes position data of the vehicle 100 and vehicle state data for each unit time. The position data is, for example, data of a target point indicating a two-dimensional coordinate position on the road, and the vehicle state data is vehicle speed data indicating the vehicle speed, direction data indicating the direction of the vehicle 100, or the like. The travel plan is updated every unit time.

The action plan generation unit 45 generates the target path by connecting the position data for each unit time Δt from the present time point to the predetermined time T ahead in time order. At this time, the acceleration (target acceleration) for each unit time Δt is calculated based on the vehicle speed (target vehicle speed) of each target point for each unit time Δt on the target path. That is, the action plan generation unit 45 calculates the target vehicle speed and the target acceleration. The target acceleration may be calculated by the driving control unit 46.

When the action plan generation unit 45 generates the target path, the action plan generation unit 45 first determines a travel mode. Specifically, the travel mode is determined, such as following traveling for following a preceding vehicle, overtaking traveling for overtaking a preceding vehicle, lane change traveling for changing a traveling lane, merging traveling for merging into a main line of a highway or a toll road, lane keeping traveling for keeping the lane so as not to deviate from the traveling lane, constant speed traveling, deceleration traveling, or acceleration traveling. Then, the target path is generated based on the travel mode.

In the self-drive mode, the driving control unit 46 controls each of the actuators AC so that the vehicle 100 travels along the target path generated by the action plan generation unit 45. That is, the throttle actuator, the shift actuator, the brake actuator, the steering actuator, and the like are controlled so that the vehicle 100 passes through a target point P for each unit time.

More specifically, the driving control unit 46 calculates a requested driving force for obtaining the target acceleration for each unit time calculated by the action plan generation unit 45 in consideration of travel resistance determined by a road gradient or the like in the self-drive mode. Then, for example, the actuators AC are feedback controlled so that an actual acceleration detected by the internal sensor group 32 becomes the target acceleration. That is, the actuators AC are controlled so that the vehicle 100 travels at the target vehicle speed and the target acceleration. In the manual drive mode, the driving control unit 46 controls each of the actuators AC in accordance with a travel command (accelerator opening or the like) from the driver acquired by the internal sensor group 32.

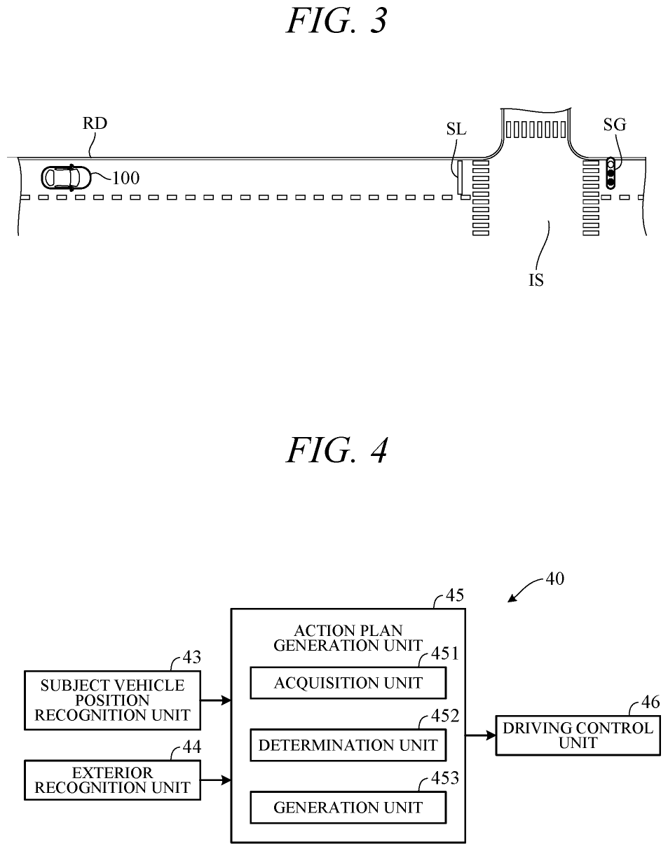

Meanwhile, as illustrated in FIG. 3, when a traffic light SG is provided at an intersection IS ahead in a traveling direction (right direction in the figure) of the vehicle 100 traveling on a road RD, scheduled switching information of the traffic light SG is sometimes transmitted from a roadside device (not illustrated) to the vehicle 100 by road-to-vehicle communication (V2I communication) or the like. The road RD is a road having one lane on one side of left-hand traffic. Hereinafter, a traffic light configured so that a display mode can be switched among a green color indicating travel permission, a red color indicating a stop instruction at the road stop line, and a yellow color indicating a notice of switching from the green color to the red color will be described as an example. The scheduled switching information includes information capable of specifying a current light color of the traffic light and a switching timing of the light color.

When the vehicle control apparatus 10 receives the scheduled switching information from the roadside device via the communication unit 37, the vehicle control apparatus 10 determines a margin time required until the traffic light SG is switched to the red color based on the scheduled switching information. Then, when the vehicle control apparatus 10 determines that the vehicle 100 cannot pass through the intersection IS before the traffic light SG is switched to the red color based on the margin time, the position of the vehicle 100 and the speed (traveling speed) of the vehicle 100, the vehicle control apparatus 10 performs a stop operation of stopping the vehicle 100 at the road stop line (road stop line SL corresponding to the traffic light SG). At this time, if the stop operation is started before the traffic light SG is switched to the red color, an occupant feels uncomfortable. In particular, when the traffic light SG is green, that is, when the stop operation is started before the traffic light SG is switched to the yellow color, the occupant tends to feel uncomfortable. Thus, in order to solve such a problem, in the present embodiment, the vehicle control apparatus 10 is configured as follows.

FIG. 4 is a block diagram illustrating a configuration of the controller 40 in FIG. 2, mainly a configuration of the action plan generation unit 45 in more detail. As illustrated in FIG. 4, the vehicle control apparatus 10 includes an acquisition unit 451, a determination unit 452, and a generation unit 453 as functional configurations.

The acquisition unit 451 acquires the scheduled switching information of the traffic light SG. More specifically, the acquisition unit 451 receives the scheduled switching information of the traffic light SG from the roadside device (not illustrated) through V2I communication via the communication unit 37.

The determination unit 452 calculates the margin time required until the traffic light SG is switched from the green color to the red color based on the scheduled switching information acquired by the acquisition unit 451. The determination unit 452 determines whether to perform the stop operation based on the calculated margin time, the position of the vehicle 100 (distance to the traffic light SG) recognized by the subject vehicle position recognition unit 43, and the traveling speed of the vehicle 100 detected by the internal sensor group 32 (vehicle speed sensor).

When the determination unit 452 determines to perform the stop operation, the generation unit 453 generates an action plan during the stop operation. At this time, the generation unit 453 generates the action plan during the stop operation so as to decelerate the vehicle 100 at a deceleration equal to or less than a predetermined deceleration (hereinafter, also referred to as a first deceleration) until the traffic light SG switches from the green color to the yellow color. The first deceleration is the deceleration (for example, −0.03 G) at which the occupant does not notice that the vehicle 100 is decelerating, and is the deceleration at which a brake lamp does not operate. The deceleration is a negative value of an acceleration (acceleration in the front-rear direction) of the vehicle 100. Hereinafter, the stop operation of decelerating the vehicle 100 at the deceleration equal to or less than the first deceleration is referred to as the preliminary deceleration, and the stop operation after the preliminary deceleration in which the vehicle 100 is decelerated so that the vehicle 100 stops at the road stop line SL is referred to as the basic deceleration.

When the determination unit 452 determines to perform the stop operation, the determination unit 452 determines whether or not the preliminary deceleration is necessary during the stop operation. When the determination unit 452 determines that the preliminary deceleration is necessary, the generation unit 453 generates an action plan for performing the preliminary deceleration and the basic deceleration.

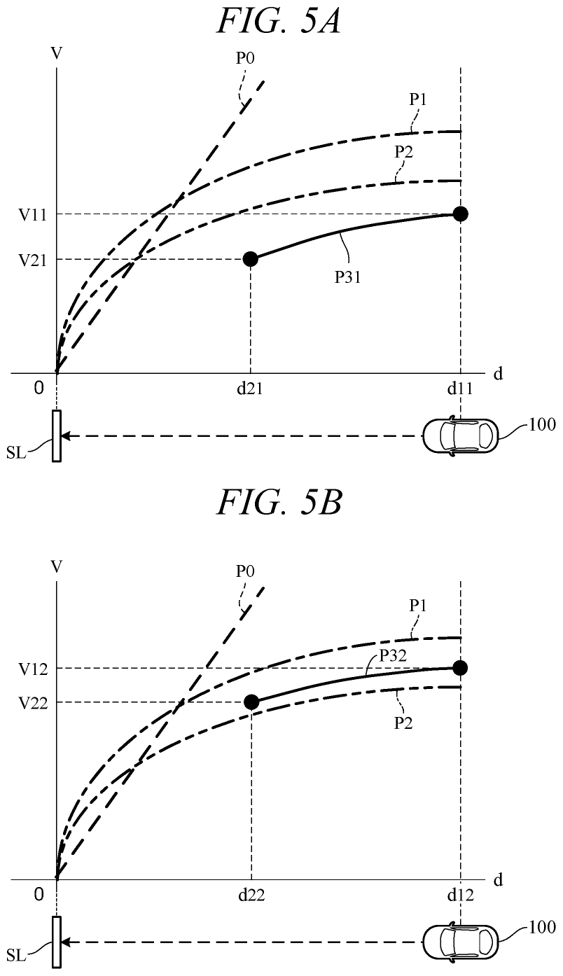

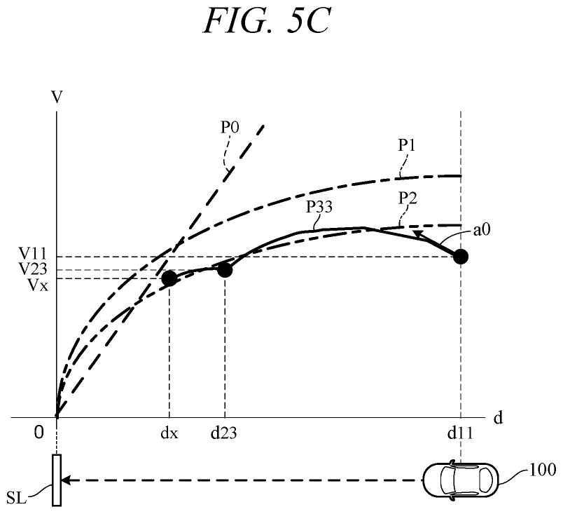

Here, the determination as to whether or not the preliminary deceleration is necessary will be described. FIGS. 5A and 5B are diagrams illustrating a relationship between the position of the vehicle 100 (distance from the road stop line SL) and the traveling speed of the vehicle 100. In FIGS. 5A and 5B, a characteristic P0 indicates the relationship between the position and the traveling speed of the vehicle 100 that can pass through the road stop line SL before the traffic light SG is switched to the yellow color. When a current traveling speed of the vehicle 100 is larger than a value (traveling speed) of the characteristic P0 corresponding to the current position of the vehicle 100, the vehicle 100 can pass through the road stop line SL before the traffic light SG is switched to the yellow color. A characteristic P1 indicates a relationship between a position d and a traveling speed V of the vehicle 100 that is expected when the vehicle 100 is decelerated at a maximum deceleration (for example, −0.3 G) allowed during deceleration. A characteristic P2 indicates a relationship between the position d and the traveling speed V of the vehicle 100 that is expected when the vehicle 100 is decelerated at a second deceleration (for example, −0.2 G) that is larger than the first deceleration and smaller than the maximum deceleration. The second deceleration is set in advance based on a result of sensory evaluation or the like.

A characteristic P31 in FIG. 5A indicates a relationship between the position and the traveling speed of the vehicle 100 that is expected when the vehicle 100 starts the preliminary deceleration at a position d11. The traveling speed of the vehicle 100 at the position d11 is V11. At this time, the determination unit 452 predicts (calculates) a position where the preliminary deceleration ends and the traveling speed of the vehicle 100 at the position based on the current position (distance to the traffic light SG) and the traveling speed of the vehicle 100. As illustrated in FIG. 5A, when a traveling speed V21 of the vehicle 100 at a position d21 where the preliminary deceleration ends are predicted to be smaller than a value of the characteristic P2 at the position d21, the determination unit 452 determines that the preliminary deceleration is unnecessary. In FIG. 5A, a characteristic P31 is illustrated only up to the end of the preliminary deceleration in order to simplify the figure.

A characteristic P32 in FIG. 5B indicates a relationship between the position and the traveling speed of the vehicle 100 that is expected when the vehicle 100 starts the preliminary deceleration at a position d12. The traveling speed of the vehicle 100 at the position d12 is V12 (>V11). As illustrated in FIG. 5B, when a traveling speed V22 of the vehicle 100 at a position d22 where the preliminary deceleration ends are predicted to be equal to or more than the value of the characteristic P2 at the position d22, the determination unit 452 determines that the preliminary deceleration is necessary. At this time, the generation unit 453 creates the action plan for performing the preliminary deceleration and the basic deceleration. In FIG. 5B, only the characteristic P32 during the preliminary deceleration is illustrated is illustrated in order to simplify the figure. As described above, by performing the preliminary deceleration when the traveling speed of the vehicle 100 at the position where the preliminary deceleration ends is predicted to be equal to or more than the value of the characteristic P2, it is possible to suppress that the preliminary deceleration is unnecessarily performed even though the vehicle 100 can pass through the road stop line SL within the margin time if the preliminary deceleration is not performed.

If the deceleration is rapidly changed when the vehicle 100 is decelerated, jerk (rate of change in deceleration) exceeds a predetermined range, which causes discomfort to the occupant. In particular, when the preliminary deceleration is started while the vehicle 100 is accelerating, the jerk becomes larger, and the discomfort of the occupant becomes larger. Therefore, it is preferable to perform the stop operation considering the jerk. More specifically, in the preliminary deceleration, it is preferable that the vehicle 100 is decelerated so that the jerk does not exceed the predetermined range, that is, the deceleration gradually approaches the first deceleration. Similarly, when the basic deceleration is started, it is preferable that the vehicle 100 is decelerated so as to gradually increase the deceleration.

When the vehicle control apparatus 10 is configured to perform the stop operation in consideration of the jerk, the determination as to whether or not the preliminary deceleration is necessary is performed as follows. For example, when the acceleration of the vehicle 100 at the position d11 is a0 (>0) in a situation illustrated in FIG. 5A, if the stop operation considering the jerk is performed, a characteristic (the relationship between the position and the traveling speed of the vehicle 100) P33 as illustrated in FIG. 5C is obtained. When the vehicle control apparatus 10 is configured to perform the stop operation in consideration of the jerk, the determination unit 452 determines that the preliminary deceleration is necessary when a traveling speed Vx at a predetermined position dx instead of a position d23 at which the preliminary deceleration ends is predicted to be equal to or more than the value of the characteristic P2 at the predetermined position dx. The predetermined position dx is a position of the vehicle 100 at which the deceleration of the vehicle 100 that has started the basic deceleration is predicted to reach the second deceleration. On the other hand, when the traveling speed Vx at the predetermined position dx is predicted to be smaller than the value of the characteristic P2, the determination unit 452 determines that the preliminary deceleration is unnecessary. As a result, even when the vehicle control apparatus 10 is configured to perform the stop operation in consideration of the jerk, it is possible to suppress that the preliminary deceleration is unnecessarily performed even though the vehicle 100 can pass through the road stop line SL within the margin time if the preliminary deceleration is not performed. The determination unit 452 predicts (calculates) the predetermined position dx based on the current position of the vehicle 100 (distance to the traffic light SG), recognized by the subject vehicle position recognition unit 43, and the traveling speed and the acceleration detected by the internal sensor group 32 (vehicle speed sensor and acceleration sensor).

The driving control unit 46 performs stop control to control the stop operation of the vehicle 100 in accordance with the action plan generated by the generation unit 453. When the preliminary deceleration is performed in accordance with the action plan, the driving control unit 46 dose not drive the brake actuator but controls the throttle actuator to reduce the opening degree of the throttle valve 11, and thus to reduce a travel driving force. When the vehicle 100 is an electric vehicle and is provided with the traveling motor as the drive source, the traveling motor is controlled to reduce the travel driving force.

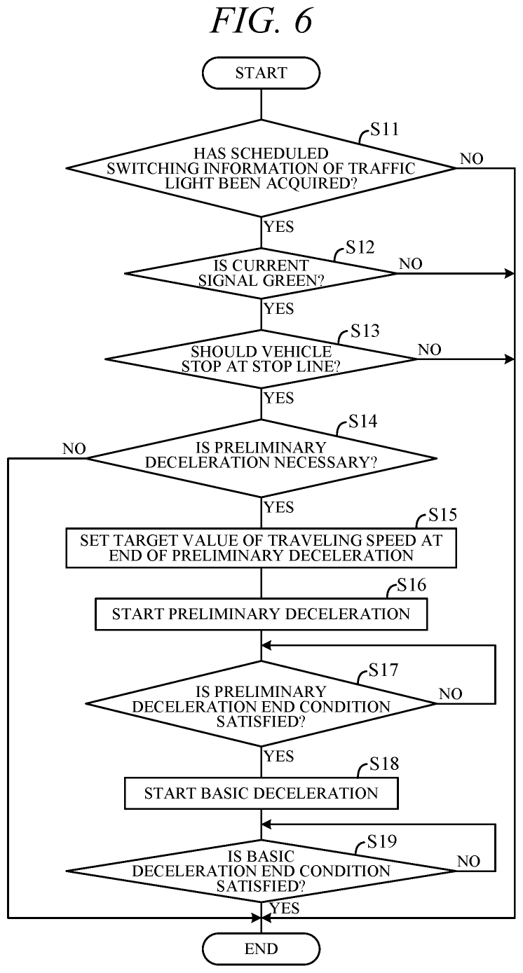

FIG. 6 is a flowchart showing an example of processing executed by the CPU of the controller 40 in FIG. 4 according to a program stored in the memory unit 42 or the like in advance. The processing illustrated in the flowchart is started, for example when the controller 40 is powered on, and is repeated at a predetermined cycle. Processing when the vehicle control apparatus 10 is configured to perform the stop operation in consideration of the jerk will be described below.

In S11 (S: process step), it is determined whether or not the scheduled switching information of the traffic light SG has been acquired. More specifically, when the vehicle 100 is traveling toward the intersection IS as illustrated in FIG. 3, it is determined whether or not the scheduled switching information of the traffic light SG has been received from the roadside device via the communication unit 37. If the result in S11 is NO, the processing ends. If the result in S11 is YES, it is determined in S12 whether or not a current signal of the traffic light SG is a green signal, that is, whether or not the current light color of the traffic light SG is the green color based on the scheduled switching information acquired in S11. If the result in S12 is NO, the processing is ended, and the travel control corresponding to the current light color of the traffic light SG is performed. Description of the travel control performed at this time will be omitted.

If the result in S12 is YES, it is determined in S13 whether to stop the vehicle 100 at the road stop line SL based on the margin time required until the traffic light SG is switched to the red color, the current position of the vehicle 100, and the traveling speed of the vehicle 100. For example, when it is predicted that the vehicle 100 cannot pass through the road stop line SL within the margin time when the vehicle 100 travels at the current traveling speed, it is determined that the vehicle 100 is to be stopped at the road stop line SL. If the result in S13 is NO, the processing ends. In this case, the vehicle 100 passes through the intersection IS without stopping at the road stop line SL.

If the result in S13 is YES, it is determined in S14 whether or not the preliminary deceleration is necessary. Specifically, the traveling speed of the vehicle 100 at the predetermined position (the predetermined position dx in FIG. 5C) when the stop operation (the stop operation considering the jerk) is performed is predicted based on the current position, the traveling speed, and the acceleration of the vehicle 100. Then, when the predicted traveling speed of the vehicle 100 at the predetermined position is predicted to be equal to or more than the value of the characteristic P2, it is determined that the preliminary deceleration is necessary. On the other hand, when the predicted traveling speed at the predetermined position is predicted to be smaller than the value of the characteristic P2, it is determined that the preliminary deceleration is unnecessary.

If the result in S14 is YES, a target value (hereinafter, referred to as the preliminary deceleration target value) of the traveling speed of the vehicle 100 at the end of the preliminary deceleration is set in S15, and the preliminary deceleration is started in S16. In the example illustrated in FIG. 5C, V23 is set as the preliminary deceleration target value. Next, in S17, it is determined whether or not a preliminary deceleration end condition is satisfied. The preliminary deceleration end condition is satisfied when the traveling speed of the vehicle 100 reaches the preliminary deceleration target value or when the signal of the traffic light SG is no longer the green signal.

S17 is repeated until it is affirmed. That is, the preliminary deceleration is performed until the preliminary deceleration end condition is satisfied. If the result in S17 is YES, the basic deceleration is started in S18. Next, in S19, it is determined whether or not a basic deceleration end condition is satisfied. The basic deceleration end condition is satisfied when the traveling speed of the vehicle 100 becomes 0, that is, when the vehicle 100 stops. S19 is repeated until it is affirmed. If the result in S19 is YES, the processing ends.

On the other hand, If the result in S14 is NO, that is, when it is determined that the preliminary deceleration is unnecessary, this processing ends without performing the stop operation in S15 to S19 so as to leave a possibility that the vehicle 100 can pass through the road stop line SL.

According to the embodiment of the present invention, the following advantageous effects can be obtained:

(1) The vehicle control apparatus 10 includes: the positioning sensor 34 that detects the position (traveling position) of the traveling subject vehicle (the vehicle 100); the internal sensor group 32 that detects the traveling speed of the subject vehicle; the acquisition unit 451 that acquires the scheduled switching information of the traffic light (the traffic light SG in FIG. 3) which is located in the traveling direction of the subject vehicle and is configured so that the display mode can be switched among a first display mode indicating travel permission, a third display mode indicating the stop instruction at the road stop line (the road stop line SL in FIG. 3), and a second display mode indicating the notice of switching from the first display mode to the third display mode; the determination unit 452 that determines whether to perform the stop operation of stopping the subject vehicle at the road stop line based on the traveling position and the traveling speed detected by the positioning sensor 34 and the margin time required until the display mode is switched from the first display mode to the third display mode included in the scheduled switching information acquired by the acquisition unit 451; and the driving control unit 46 that, when the determination unit 452 determines to perform the stop operation, decelerates the subject vehicle at the deceleration equal to or less than the predetermined deceleration until the display mode is switched from the first display mode to the second display mode, and decelerates the subject vehicle so that the subject vehicle stops at the road stop line after the display mode is switched to the second display mode. As a result, when the traffic light is switched to the red color at the intersection, the subject vehicle can be stopped without causing discomfort to the occupant.

(2) The vehicle control apparatus 10 includes the engine 1 and the transmission 2 constituting a driving force generator that generates the travel driving force. When the determination unit 452 determines to perform the stop operation, the driving control unit 46 controls the driving force generator (the engine 1 and the transmission 2) such that the travel driving force decreases until the display mode is switched from the first display mode to the second display mode, and decelerates the subject vehicle at the deceleration equal to or less than the predetermined deceleration. The vehicle control apparatus 10 includes a braking unit 4 that decelerates the subject vehicle. When the determination unit 452 determines to perform the stop operation, the driving control unit 46 does not operate the braking unit 4 until the display mode is switched from the first display mode to the second display mode, but controls the driving force generator (the engine 1 and the transmission 2) to decelerate the subject vehicle, and after the display mode is switched to the second display mode, the driving control unit 46 operates the braking unit 4 to decelerate the subject vehicle. As a result, in the preliminary deceleration, the vehicle 100 can be decelerated without operating the braking device. Thus, it is possible to perform the preliminary deceleration in which the occupant does not feel uncomfortable.

(3) When the determination unit 452 determines to perform the stop operation, the driving control unit 46 determines a target value of the traveling speed of the subject vehicle at a time point when the display mode is switched from the first display mode to the second display mode, and decelerates the subject vehicle at the deceleration equal to or less than the predetermined deceleration until the display mode is switched from the first display mode to the second display mode so that the traveling speed of the subject vehicle becomes the target value at the time point when the display mode is switched from the first display mode to the second display mode. As described above, when the stop control is performed so that the traveling speed of the vehicle 100 at the end of the preliminary deceleration (at the start of the basic deceleration) becomes the target value, the vehicle 100 can be stopped at the position of the road stop line at the end of the basic deceleration even when the traveling speed of the vehicle 100 fluctuates due to an external factor (such as interruption of another vehicle) during the preliminary deceleration.

(4) The driving control unit 46 controls the stop operation of the subject vehicle so that the jerk that is the rate of change in deceleration is equal to or less than a predetermined range. As a result, even when the stop operation is started while the vehicle 100 is accelerating, discomfort to the occupant due to a change in deceleration (acceleration) can be suppressed. In addition, it is possible to suppress that the stop position of the vehicle 100 is shifted from the position of the road stop line due to the jerk.

In the above embodiment, the traffic light configured so that the display mode can be switched among the green color indicating travel permission, the red color indicating the stop instruction at the road stop line, and the yellow color indicating the notice of switching from the green color to the red color has been described as an example. However, the stop control of the vehicle 100 by the vehicle control apparatus 10 according to the above embodiment is also applicable to a case where the vehicle 100 passes through a location where a traffic light having another display mode is provided. For example, the traffic light SG may be, like a temporary traffic light at a road construction site, a traffic light configured so that the display mode can be switched among the green color (green color) indicating travel permission, the red color indicating the stop instruction at the road stop line, and display for several seconds until the traffic light is switched from the green color to the red color. Furthermore, for example, the traffic light SG may be an arrow type traffic light that indicates travel permission by a green arrow light.

In the above embodiment, the positioning sensor 34 detects the position of the traveling vehicle 100, and the internal sensor group 32 (vehicle speed sensor) detects the traveling speed of the vehicle 100; however, a configuration of a detector is not limited thereto. For example, the position of the traveling vehicle 100 may be detected based on the information acquired by the external sensor group 31 (camera, radar, and rider) and the map information stored in the memory unit 42.

In the above embodiment, the driving control unit 46 controls the stop operation of stopping the vehicle 100 at the road stop line based on the margin time required until the display mode is switched from the first display mode to the third display mode, the position of the vehicle 100, and the traveling speed of the vehicle 100; however, a configuration of a deceleration control unit is not limited thereto. The deceleration control unit may stop the vehicle 100 at the road stop line using other parameters.

In the above embodiment, as illustrated in FIG. 3, the case where there is no other vehicle (front vehicle) ahead in the traveling direction of the vehicle 100 has been described as an example. However, the driving control unit 46 may perform the stop control of the vehicle 100 in consideration of a distance to the front vehicle recognized by the exterior recognition unit 44, the speed of the front vehicle, and the acceleration of the front vehicle. When it is predicted that the front vehicle will stop at the road stop line based on information received from the front vehicle via the road-to-vehicle communication or vehicle-to-vehicle communication (V2V communication) and the information recognized by the exterior recognition unit 44, the driving control unit 46 may perform the stop control to stop the vehicle 100 behind the front vehicle that has stopped at the position of the road stop line.

In the above embodiment, the acquisition unit 451 receives the scheduled switching information of the traffic light SG from the roadside device through the V2I communication via the communication unit 37; however, the configuration of the acquisition unit is not limited to that described above. For example, the acquisition unit may cause the memory unit 42 to store, as the scheduled switching information, information indicating the switching timing of the traffic light recognized by the external sensor group 31 (camera) when the vehicle 100 travels near an intersection. When the vehicle passes through the traffic light SG next time, the acquisition unit may read the scheduled switching information stored in the memory unit 42. The acquisition unit may determine whether or not the scheduled switching information received from the roadside device is the scheduled switching information of the traffic light corresponding to a lane (subject vehicle lane) on which the vehicle 100 is traveling, and may not acquire the scheduled switching information of the traffic light not corresponding to the subject vehicle lane. For example, when the position information of the corresponding traffic light is included in the scheduled switching information, it may be determined whether or not the information is the scheduled switching information of the traffic light corresponding to the subject vehicle lane based on the position information.

In addition, in the above embodiment, although the vehicle control apparatus 10 is applied to the automatic driving vehicle, the vehicle control apparatus 10 is also applicable to vehicles other than the automatic driving vehicle. For example, the vehicle control apparatus 10 can also be applied to a manually driven vehicle including advanced driver-assistance systems (ADAS).

What is claimed is:

1. A vehicle control apparatus comprising:
a detection unit configured to detect a traveling position and a traveling speed of a subject vehicle; and
a microprocessor and a memory coupled to the microprocessor, wherein
the microprocessor is configured to perform:
acquiring a scheduled switching information of a traffic light located in the traveling direction of the subject vehicle and configured so that a display mode is switched among a first display mode indicating a travel permission, a third display mode indicating a stop instruction at a road stop line and a second display mode indicating a notice of switching from the first display mode to the third display mode;
determining whether to perform a stop operation of stopping the subject vehicle at the road stop line based on the traveling position and the traveling speed detected by the detection unit and a margin time required until the display mode is switched from the first display mode to the third display mode included in the scheduled switching information acquired in the acquiring; and
when it is determined to perform the stop operation, decelerating the subject vehicle at a deceleration equal to or less than a predetermined deceleration until the display mode is switched from the first display mode to the second display mode, and decelerates the subject vehicle so that the subject vehicle stops at the road stop line after the display mode is switched to the second display mode.

2. The vehicle control apparatus according to claim 1 further comprising
a driving force generation unit configured to generate a travel driving force, wherein
the microprocessor is configured to perform
when it is determined to perform the stop operation in the determining, controlling the driving force generation unit such that the travel driving force decreases until the display mode is switched from the first display mode to the second display mode to decelerate the subject vehicle at a deceleration equal to or less than the predetermined deceleration.

3. The vehicle control apparatus according to claim 2 further comprising
a braking unit configured to decelerate the subject vehicle, wherein
the microprocessor is configured to perform
when it is determined to perform the stop operation, controlling the driving force generation unit without operating the braking unit until the display mode is switched from the first display mode to the second display mode to decelerate the subject vehicle, and after the display mode is switched to the second display mode, operating the braking unit to decelerate the subject vehicle.

4. The vehicle control apparatus according to claim 1, wherein
the microprocessor is configured to perform
when it is determined to perform the stop operation, determining a target value of a traveling speed of the subject vehicle at a time point when the display mode is switched from the first display mode to the second display mode, and decelerating the subject vehicle at a deceleration equal to or less than the predetermined deceleration so that the traveling speed of the subject vehicle becomes the target value at the time point.

5. The vehicle control apparatus according to claim 1, wherein
the predetermined deceleration is a first deceleration, and
the microprocessor is configured to perform
determining not to perform the stop operation when predicting that a traveling speed of the subject vehicle at a time point when the display mode is switched from the first display mode to the second display mode is equal to or more than a traveling speed at the time point, derived by a characteristic indicating a relationship between a traveling position and a traveling speed of the subject vehicle that is expected when the subject vehicle is decelerated at a second deceleration larger than the first deceleration.

6. The vehicle control apparatus according to claim 5, wherein
the microprocessor is configured to perform
determining not to perform the stop operation when predicting that a traveling speed of the subject vehicle at a predicted position where a deceleration of the subject vehicle is predicted to reach the second deceleration after the display mode is switched to the second display mode is less than a traveling speed of the subject vehicle at the predicted position, derived by the characteristic.

7. The vehicle control apparatus according to claim 1, wherein
the microprocessor is configured to perform
control a stop operation of the subject vehicle so that a jerk which is a rate of change in a deceleration does not exceed a predetermined range.

8. A vehicle control apparatus comprising:
a detection unit configured to detect a traveling position and a traveling speed of a subject vehicle; and
a microprocessor and a memory coupled to the microprocessor, wherein
the microprocessor is configured to function as:
an acquisition unit configured to acquire a scheduled switching information of a traffic light located in the traveling direction of the subject vehicle and configured so that a display mode is switched among a first display mode indicating a travel permission, a third display mode indicating a stop instruction at a road stop line and a second display mode indicating a notice of switching from the first display mode to the third display mode;
a determination unit configured to determine whether to perform a stop operation of stopping the subject vehicle at the road stop line based on the traveling position and the traveling speed detected by the detection unit and a margin time required until the display mode is switched from the first display mode to the third display mode included in the scheduled switching information acquired by the acquisition unit; and
a deceleration control unit configured to, when it is determined to perform the stop operation by the determination unit, decelerate the subject vehicle at a deceleration equal to or less than a predetermined deceleration until the display mode is switched from the first display mode to the second display mode, and decelerates the subject vehicle so that the subject vehicle stops at the road stop line after the display mode is switched to the second display mode.

9. The vehicle control apparatus according to claim 8 further comprising
a driving force generation unit configured to generate a travel driving force, wherein
the deceleration control unit, when it is determined to perform the stop operation by the determination unit, controls the driving force generation unit such that the travel driving force decreases until the display mode is switched from the first display mode to the second display mode to decelerate the subject vehicle at the deceleration equal to or less than the predetermined deceleration.

10. The vehicle control apparatus according to claim 9 further comprising
a braking unit configured to decelerate the subject vehicle, wherein
the deceleration control unit, when it is determined to perform the stop operation, controls the driving force generation unit without operating the braking unit until the display mode is switched from the first display mode to the second display mode to decelerate the subject vehicle, and after the display mode is switched to the second display mode, operates the braking unit to decelerate the subject vehicle.

11. The vehicle control apparatus according to claim 8, wherein
the deceleration control unit, when it is determined to perform the stop operation, determines a target value of a traveling speed of the subject vehicle at a time point when the display mode is switched from the first display mode to the second display mode, and decelerates the subject vehicle at the deceleration equal to or less than the predetermined deceleration so that the traveling speed of the subject vehicle becomes the target value at the time point.

12. The vehicle control apparatus according to claim 8, wherein
the predetermined deceleration is a first deceleration, and
the determination unit determines not to perform the stop operation when predicting that a traveling speed of the subject vehicle at a time point when the display mode is switched from the first display mode to the second display mode is equal to or more than a traveling speed at the time point, derived by a characteristic indicating a relationship between a traveling position and a traveling speed of the subject vehicle that is expected when the subject vehicle is decelerated at a second deceleration larger than the first deceleration.

13. The vehicle control apparatus according to claim 12, wherein
the determination unit determines not to perform the stop operation when predicting that a traveling speed of the subject vehicle at a predicted position where a deceleration of the subject vehicle is predicted to reach the second deceleration after the display mode is switched to the second display mode is less than a traveling speed of the subject vehicle at the predicted position, derived by the characteristic.

14. The vehicle control apparatus according to claim 8, wherein
the deceleration control unit controls the stop operation of the subject vehicle so that a jerk which is a rate of change in a deceleration does not exceed a predetermined range.
